(19) United States
(12) Patent Application Publication
(10) Pub. No.: US 2023/0228591 A1
(43) Pub. Date: Jul. 20, 2023

(54) SYSTEM AND METHOD OF COLLABORATIVELY REFINING HIGH DEFINITION MAPS FOR AUTONOMOUS PARKING OF A VEHICLE

(71) Applicant: Faraday&Future Inc., Gardena, CA (US)

(72) Inventors: Shyam Sundar, San Diego, CA (US); Anupama Kuruvilla, Irvine, CA (US)

(21) Appl. No.: 17/575,919

(22) Filed: Jan. 14, 2022

(51) Int. Cl. G01C 21/00; B60W 60/00

(52) U.S. Cl. CPC G01C 21/3807; G01C 21/3885; B60W 60/0025; B60W 2556/40; B60W 2556/45; B60W 2554/40; B60W 2554/20

(57) ABSTRACT

A computer-implemented method of refining a high definition (HD) map of a parking lot for autonomous vehicle parking (AVP) is disclosed. The method including: a vehicle navigating in the parking lot using the HD map; the vehicle using one or more sensors to scan for objects in the parking lot; the vehicle augmenting the HD map using a simultaneous localization & mapping SLAM method; adding objects detected by the one or more sensors to the HD map; and contributing towards improving a learning score of the HD map.

### FIELD

This relates generally to refining maps for vehicles, and specifically relates to collaboratively refining High Definition (HD) maps of parking lots for autonomous valet parking of a vehicle.

### BACKGROUND

Autonomous Valet Parking (AVP) is a self-driving car feature wherein the vehicle navigates on its own in a parking lot or structure, finds itself an available parking space and parks itself. The feature enables the owner of a self-driving car to alight from the car at the entrance of a parking lot/structure and command the car to park itself. Later, the owner can command the car to come and pick them up at the same spot where it dropped them off. This is considered a time-saving convenience feature of self-driving cars.

### SUMMARY

In one aspect, a computer-implemented method of refining an high definition (HD) map of a parking lot for autonomous vehicle parking (AVP) is disclosed. The method can include: a vehicle navigating in the parking lot using the HD map; the vehicle using one or more sensors to scan for objects in the parking lot; the vehicle augmenting the HD map using a simultaneous localization & mapping SLAM method; adding objects detected by the one or more sensors to the HD map; and contributing towards improving a learning score of the HD map.

In another aspect of the disclosure, another computer-implemented method of improving an accuracy of a HD map of a parking lot is disclosed. The method includes: initialize a learning score of the HD map; transmitting the HD map to a plurality of vehicles configured to augment the HD map; receiving an augmented HD map from each of the plurality of vehicles; updating the HD map with information from the augmented HD maps; and adjusting the learning score of the HD map in response to the information from the augmented HD maps.

In yet another aspect of the disclosure, a vehicle is disclosed. The vehicle includes: one or more sensors configured to detect objects in a parking lot; a communication module configured to transmit and receive a high definition map; a processor; and a non-transitory storage configured to store instructions, which when executed by the processor, cause the processor to perform a method including: navigating the vehicle in a parking lot using the HD map; using the one or more sensors to scan for objects in the parking lot; augmenting the HD map using a simultaneous localization & mapping (SLAM) method; adding objects detected by the one or more sensors to the HD map; and contributing towards improving a learning score of the HD map.

### BRIEF DESCRIPTION OF THE DRAWINGS

FIG. 1 is a flow chart illustrating the exemplary steps in a method of collaboratively refining an HD map of a parking lot for AVP using SLAM and with the application of a learning score, according to an embodiment of the disclosure.

FIG. 2 depicts a block diagram of a system for refining maps for vehicles, according to an embodiment of this disclosure.

FIG. 3 depicts a block diagram of multiple vehicles connected to a remote server, each vehicle contributing to the learning score of the HD map, according to an embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

Generally described, the present disclosure relates to systems and methods of collaboratively refining High Definition (HD) maps of parking lots for AVP of a vehicle using simultaneous localization & mapping (SLAM) technique and the application of Learning Scores.

The size, shape, and configuration of parking areas can vary greatly. For example, some parking areas are open-air parking lots and others are closed multi-story or underground parking structures. The techniques described in this application can be used in any of these parking areas. Existing methods are available for autonomous vehicles to navigate parking areas. For example, autonomous vehicles can use their own sensors—for example, cameras, radars, LIDARs, ultrasound sensors—as well as external aids such as signage, radio beacons, etc., to find their current position, or localization, in the parking area. The car's current position can assist in planning their path to an available empty parking space located in the parking area. This method of using sensors to navigate is sometimes referred to as SLAM.

Autonomous Vehicles rely on HD Maps of the parking lot/structure to navigate within the space. The HD Map of a parking lot/structure can depict a static view of the space with some of the static obstacles and boundaries captured. They do not capture dynamic details such as parked cars, pedestrians, moving obstacles, etc. Even with static objects, the HD Map may not have captured 100% of the details due to limitations of the existing methods used to create the HD Map. For example, a HD Map created from high resolution aerial images may not capture obstacles such as thin fences which obstruct the path of the vehicle.

Embodiments of the present disclosure introduce the concept of learning score or confidence Score to indicate the level of confidence in the detail captured by an HD Map. For example, HD Maps with a learning score of 100% depict all static obstacles, objects and constructs in the space accurately to allow an autonomous vehicle to navigate safely within the space. In some embodiments, 100% can be the theoretical maximum achievable although it may be an unachievable score in practice. Multiple methods of constructing and refining the HD maps can be required to achieve as close to a 100% learning score as possible. The methods may disagree with each other and may sometimes lead to reductions in the learning score as well.

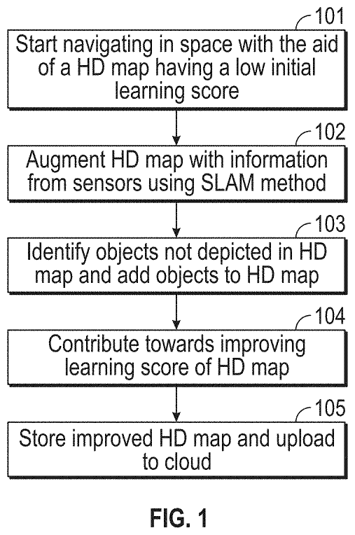

FIG. 1 illustrates the exemplary steps of a method of collaboratively refining an HD map of a parking lot for AVP using SLAM and with the application of a learning score. First, the autonomous vehicle starts navigating in a space with the aid of a HD Map that may initially have a low learning score, say 30-40%. (Step 101) The vehicle may augment the HD Map with information from its own sensors using the SLAM method. (Step 102) With SLAM, the autonomous vehicle perceives dynamic objects not represented in the HD Map as well as static objects that the methods used to construct the HD Map may have missed. As the autonomous vehicle using SLAM identifies possible static objects that are not currently depicted by the HD Map but should, the vehicle adds these objects to the HD Map (Step 103) and contributes towards improving the learning score of the HD Map (Step 104). The improved HD Map can be stored in local storage or uploaded to the cloud to be used by other autonomous vehicles. (Step 105) The other autonomous vehicles, in turn, may also contribute to the improvement of learning score of the HD Map through their own SLAM sensors and perception algorithms (e.g., by performing steps 101-105 of FIG. 1).

The continuous process of inheritance of a parking lot HD Map with a known learning score by an autonomous vehicle, improvement of its learning score through the SLAM method, and transmission back to the cloud storage with the improved score for the benefit of other autonomous vehicles is the core of this disclosure. With the diversity of sensors and perception algorithms across a fleet of autonomous vehicles that use this method, the learning scores of parking lot HD Maps can be brought close to 100% in a collaborative manner.

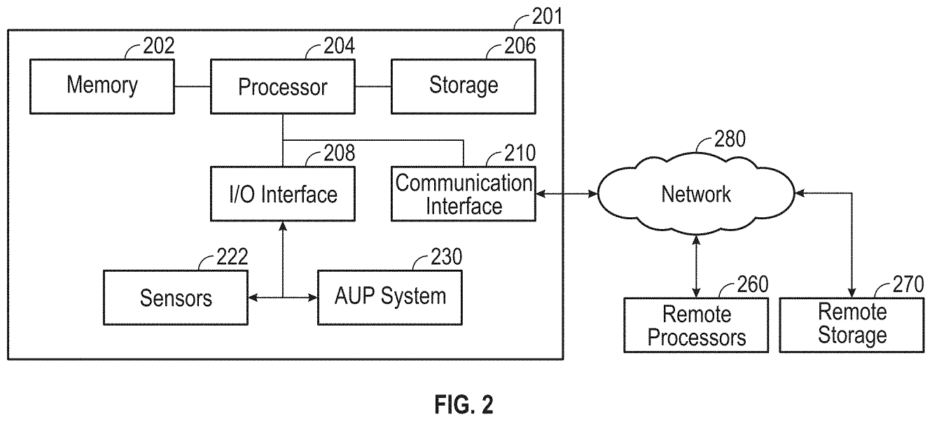

FIG. 2 depicts a block diagram of a system for refining HD maps for autonomous vehicles, according to examples of this disclosure. For example, system 200 may be employed to perform the methods described above with reference to FIG. 1. Referring to FIG. 2, system 200 may include a vehicle 201, the vehicle 200 may include, among other things, a memory 202, a processor 204, a storage 206, an input/output (I/O) interface 208, a communication interface 210, one or more sensors 220, and an autonomous valet parking (AVP) system 230. At least some of these components of vehicle 201 may be configured to transfer data and send or receive data between or among each other.

Communication interface 210 may be configured to communicate with mobile terminal remote processors 260, and a remote storage 270 via network 280. Network 280 may be any type of wired or wireless network that may allow transmitting and receiving data. For example, network 280 may be a wired network, a local wireless network (e.g., Bluetooth™, WiFi, near field communications (NFC), etc.), a cellular network, an Internet, or the like, or a combination thereof. Other known communication methods which provide a medium for transmitting data are also contemplated.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors), such as processors 204 and 260 depicted in FIG. 2, that executes program instructions or modules stored in a memory or other non-transitory computer-readable storage medium or device (e.g., solid state storage devices, disk drives, etc.), such as storage 206 and remote storage 270 depicted in FIG. 2. The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

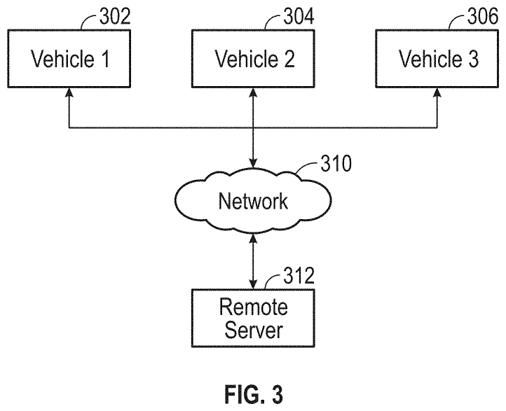

FIG. 3 illustrates a network of vehicles 302, 304, 306 connected to the same network 310. Each of the vehicles 302, 304, 306 can be a vehicle with an AVP system capable of performing automatic vehicle parking function in a park lot. An HD map can be provided by the remote server 312 over the network 310. Each vehicle 302, 304, 306, while driving through the parking lot(s), may augment the HD Map information with its own sensors using, for example, the SLAM method. As the vehicles 302, 304, 306 identifies possible static objects that are not currently depicted by the HD Map but should, the vehicle modifies the HD Map by adding the identified objects to the HD map and uploads the modified map to the remote server 312.

The remote server 312 collects the modified HD maps from the vehicles 302, 304, 306 and updates the master HD map stored on the remote server 312 to reflect the new objects detected by the vehicles 302, 304, 306. The remote server 312 can also update the learning score of the HD map based on the feedback from the vehicles 302, 304, 306. For example, the remote server 312 can increase the learning score of the HD map when additional objects are added to the map. In one embodiment, the learning score can have a more significant increase if multiple vehicles add the same object to the HD map. In contrast, the learning score can be decreased when conflicting date is received from multiple vehicles. The learning score can provide a confidence level associated with the HD map. The latest HD map, once updated, can be made available for downloading to vehicles 302, 304, 306.

Network 312 may be any type of wired or wireless network that may allow transmitting and receiving data. It should be understood that although 3 vehicles are illustrated in FIG. 3, any number of vehicles can be connected to the remote server 310 via the network 312.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A computer-implemented method of refining a high definition (HD) map of a parking lot for autonomous vehicle parking (AVP), the method comprising:
a vehicle navigating in the parking lot using the HD map;
the vehicle using one or more sensors to scan for objects in the parking lot;
the vehicle augmenting the HD map using a simultaneous localization & mapping SLAM method;
adding objects detected by the one or more sensors to the HD map; and
contributing towards improving a learning score of the HD map.

2. The computer-implemented method of claim 1, wherein the HD map having a learning score associated with an accuracy of the HD map.

3. The computer-implemented method of claim 1, further comprising uploading to a remote server the HD map after objects are added to the HD map.

4. A computer-implemented method of improving an accuracy of a HD map of a parking lot, the method comprising:
initialize a learning score of the HD map;
transmitting the HD map to a plurality of vehicles configured to augment the HD map;
receiving an augmented HD map from each of the plurality of vehicles;
updating the HD map with information from the augmented HD maps; and
adjusting the learning score of the HD map in response to the information from the augmented HD maps.

5. The computer-implemented method of claim 4, wherein the plurality of vehicles are configured to augment the HD map using a simultaneous localization & mapping (SLAM) method.

6. The computer-implemented method of claim 4, wherein adjusting the learning score of the HD map in response to the information from the augmented HD maps comprises increasing the learning score if the information from the augmented HD maps is consistent.

7. The computer-implemented method of claim 4, wherein adjusting the learning score of the HD map in response to the information from the augmented HD maps comprises decreasing the learning score if the information from the plurality of HD maps contradict each other.

8. A vehicle comprising:
one or more sensors configured to detect objects in a parking lot;
a communication module configured to transmit and receive a high definition map;
a processor; and
a non-transitory storage configured to store instructions, which when executed by the processor, cause the processor to perform a method comprising:
navigating the vehicle in a parking lot using the HD map;
using the one or more sensors to scan for objects in the parking lot;
augmenting the HD map using a simultaneous localization & mapping (SLAM) method;
adding objects detected by the one or more sensors to the HD map; and
contributing towards improving a learning score of the HD map.
